(19) United States
(12) Patent Application Publication
(10) Pub. No.: US 2025/0206176 A1
(43) Pub. Date: Jun. 26, 2025

(54) ELECTRIFIED MACHINE AND CHARGER FLEET AND MICROGRID POWER DISPATCH

(71) Applicant: Caterpillar Inc., Peoria, IL (US)

(72) Inventors: Suresh Baddam Reddy, Peoria, IL (US); Daniel Jude Organ, Peoria, IL (US); Neil Alan Roth, Germantown Hills, IL (US); Steven F. Gupman, Peoria, IL (US); Srideep Chatterjee, Bhopal (IN)

(73) Assignee: Caterpillar Inc., Peoria, IL (US)

(21) Appl. No.: 18/393,108

(22) Filed: Dec. 21, 2023

(51) Int. Cl. B60L 53/64; B60L 53/62; B60L 58/12; B60L 58/16; H02J 3/00; H02J 7/00

(52) U.S. Cl. CPC B60L 53/64; B60L 53/62; B60L 58/12; B60L 58/16; H02J 3/003; H02J 7/0071; B60L 2200/40; B60L 2260/52

(57) ABSTRACT

A method of controlling a work site includes calculating energy demand by work machines to perform work over a predetermined time window; generating a charging schedule for the predetermined time window, wherein the charging schedule pairs chargers to the work machines and includes charging wait times for charging the work machines; generating a power dispatch schedule of activating, deactivating, apportioning power levels of energy assets of a microgrid system of the work site to supply the calculated energy demand during the predetermined time window; determining a difference between energy to be supplied by the energy assets and the energy demand for the predetermined time window; and operating the energy assets according to the power dispatch schedule and the chargers according to the charging schedule, and activating one or more energy storage systems of the microgrid system according to the determined difference between the energy demand and the energy supplied.

### TECHNICAL FIELD

This document relates to an energy microgrid system to power a fleet of electrified work machines.

### BACKGROUND

Powering large moving work machines (e.g., wheel loaders, mining trucks, etc.) electrically with zero emissions sources requires a large mobile electric energy source (e.g., an energy storage battery or battery system) or a tethered electrical connection that can provide current (e.g., tens to hundreds of Amperes (Amps) of current). A job site where several large electric work machines operate can often be a remote location where work machines that use energy storage batteries need to be recharged and tethered or trolleyed work machines need off-board energy storage systems to stabilize voltage and frequency and minimize electricity charges during periods of peak electricity rates and/or peak electricity demand. Additionally, at remote job sites, the utility grid electrical infrastructure for charging the batteries of the work machines or the off-board energy storage systems is either very limited or non-existent. A microgrid can be constructed at job sites to provide or enhance the infrastructure to provide energy to power the work machines. A microgrid can use energy produced by different types of energy assets, such as generator sets (or gensets), battery energy storage systems (ESSs), photovoltaic sources (e.g., solar panels), wind turbines, fuel cells, hydrogen production and storage, etc., to provide energy to the job site. It is desirable to control the microgrid to provide reliable power with low operating cost, low emissions, and high use of renewable energy. Additionally, the machines need to maximize their productivity, minimizing charging times, including travel to charging stations, waiting for charging.

The traditional problem of scheduling machines for productivity at a site is compounded with availability impacted by charging requirements, scheduling of travel between machines and chargers (whether fixed or mobile), interlinkage with scheduling of chargers, and economics of electricity charging from the electrical grid or a microgrid. While traditional problems of microgrid economic dispatch and scheduling of machines for productivity are dealt with in various ways, the problem addressed here is the problem of addressing both when the microgrid dispatch and machine scheduling are coupled. Similar problem exists with machines using hydrogen produced via electrolysis onsite-economic production of hydrogen using electricity, scheduling of hydrogen fuel stations and machines for fueling are linked together with problems of machines productivity and economic electricity production and use onsite.

### SUMMARY OF THE INVENTION

Electric powered large moving work machines use large capacity battery systems that need charging. It is desired to provide power to the work machines at a remote job site using a microgrid system that utilizes diverse energy assets to provide energy to the microgrid system.

An example method of controlling a work site includes calculating, by a site controller of the work site, energy demand by the work machines to perform the work over a predetermined time window; generating a charging schedule for the predetermined time window, wherein the charging schedule pairs chargers of the work site to the work machines and includes travel times and wait times for charging work machines; generating a power dispatch schedule of activating and deactivating energy assets of a microgrid system of the work site and apportioning power levels of the energy assets to supply the calculated energy demand during the predetermined time window; determining a difference between energy to be supplied by the energy assets during the predetermined time window and the energy demand for the predetermined time window; and operating the energy assets according to the power dispatch schedule and the chargers according to the charging schedule, and activating one or more energy storage systems of the microgrid system according to the determined difference between the energy demand and the energy supplied.

An example microgrid system includes multiple energy assets including renewable and non-renewable energy assets; a computing resource; and a system optimizer application to execute on the computing resource and configured to: calculate energy demand on the microgrid system by the work machines over a predetermined time window; calculate a cost of operating the microgrid system and the work machines during the predetermined time window; determine a schedule to optimize productivity of operating the work machines during the predetermined time window, wherein the schedule includes a charging schedule for the work machines and a power dispatch schedule for energy assets of the microgrid system; and activate and deactivate the energy assets of the microgrid system, and apportion power levels of the energy assets during the predetermined time window according to the activation/deactivation schedule.

An example site controller includes processing circuitry configured to calculate energy demand on the microgrid system by multiple work machines over a predetermined time window, generate a charging schedule to pair chargers of the work site to the work machines for the predetermined time window, generate a power dispatch schedule of activating and deactivating energy assets of the microgrid system and apportioning power levels of the energy assets to supply the calculated energy demand, determine a difference between energy to be supplied by the energy assets during the predetermined time window and the energy demand for the predetermined time window, and operate the energy assets according to the power dispatch schedule and activate one or more energy storage systems according to the determined difference between the energy demand and the energy supplied.

### BRIEF DESCRIPTION OF THE DRAWINGS

FIG. 1 is an illustration of an example of a work site in accordance with this disclosure.

FIG. 2 is an illustration of an example microgrid system in accordance with this disclosure.

FIG. 3 is a block diagram of a site controller in accordance with this disclosure.

FIG. 4 is a block diagram of an overview of the management of a microgrid system by a microgrid controller in accordance with this disclosure.

FIG. 5 is a block diagram of an example computing device in accordance with this disclosure.

FIG. 6 is a flow diagram of an example of a method of operating a microgrid system in accordance with this disclosure.

### DETAILED DESCRIPTION

Examples according to this disclosure are directed to methods and systems that improve efficiency of an energy microgrid system.

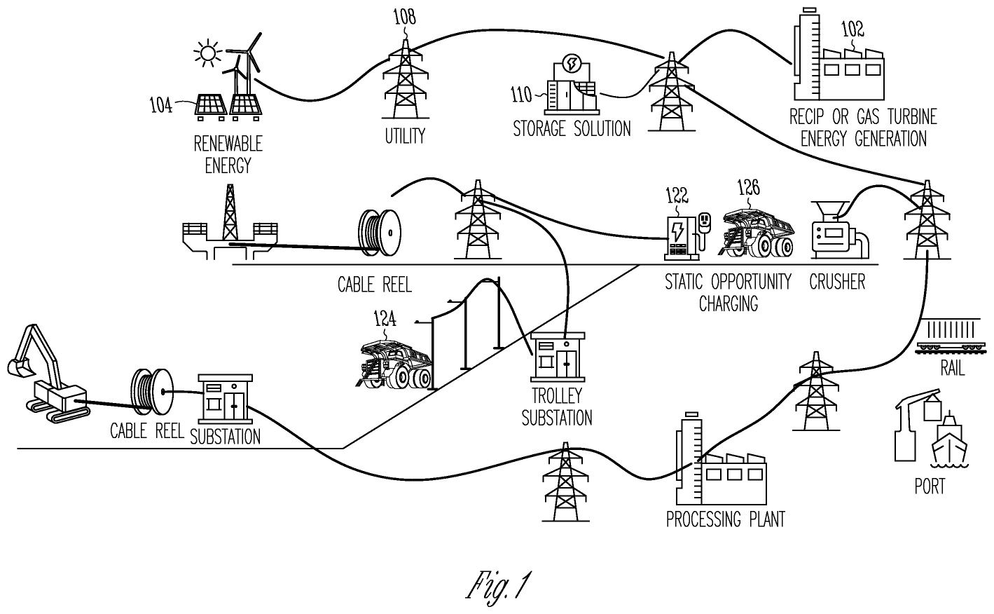

FIG. 1 is an illustration of a work site (e.g., a mining site). The work site can include a fleet of work machines including tethered/trolleyed work electric work machines 124 and work machines 126 that include batteries chargeable using chargers 122 of the work site. The work site includes a microgrid system to provide energy to the moving work machines and stationary work machines. The microgrid can receive energy from a utility grid 108, gensets 102, renewable energy assets 104, and energy storage solutions 110.

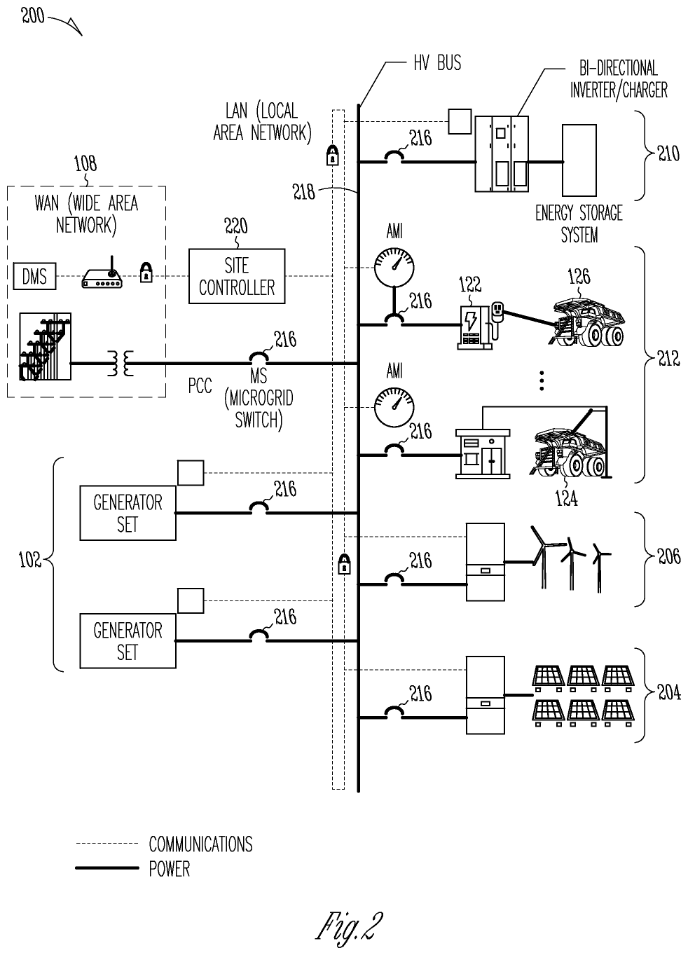

FIG. 2 is an illustration of portions of an example of a microgrid system 200, such as to provide energy to charge the work machines at the remote job site. The microgrid system 200 includes multiple energy assets of different types connected to a high voltage bus 218 (HV Bus) through microgrid switches 216. The example of FIG. 2 shows groups of energy assets that include fueled assets such as gensets 102, and renewable energy assets such as photovoltaics 204 and wind turbines 206. The gensets 102 can be diesel fueled, gas reciprocating, gas turbines, hydrogen reciprocating, hydrogen turbines, blended fuel gensets, etc. In a zero emissions site, the energy assets will be confined to assets such as photovoltaics, wind turbines, hydro-electric, energy storage, hydrogen fuel cells, hydrogen gensets, with hydrogen produced onsite via electrolysis using renewables. The microgrid system 200 may include a connection to a utility grid 108.

The microgrid system 200 also includes one or more energy storage systems 210 (ESSs). An ESS 210 can include battery systems, hydrogen storage systems with electrolyzer, pumped hydro-electric systems, etc. An ESS 110 of the microgrid system 100 can be used to store energy excess energy created by energy assets or to store energy from the utility grid 108 during times when grid energy is lower cost. The stored energy can be used to power work machines. There can be multiple loads 212 on the microgrid system 100. For example, if the microgrid system 200 is powering a mining site, the loads 212 can include chargers 222 for battery powered work machines 226, tethered/trolleyed work machines 124, and stationary work machines to process the material collected at the mining site.

The microgrid system 200 includes a site controller 220. The site controller 220 includes processing circuitry that includes one or more processors (e.g., one or more microprocessors, digital signal processors (DSP), application specific integrated circuits (ASICs), programmable gate arrays (PGAs), or equivalent discrete or integrated logic circuitry). The site controller 220 can include memory to store instructions performable by the processing circuitry. The instructions may be software or firmware instructions and the instructions configure the processing circuitry to perform the functions described for the site controller 220. For example, the site controller 220 may be programmed with a software application (or app) for the processing circuitry of the microgrid controller 220 to perform the operations described.

Power scheduling for a microgrid based on energy costs and operating costs is typically treated as a separate problem from scheduling the work machines and other equipment at the job site. However, a complex microgrid system can include many groups of energy assets of different types, including different types of renewable and non-renewable energy assets.

With a microgrid system that is complex and a job site fleet that is a mix of work machines that are battery powered and tethered, power scheduling and machine scheduling become interlinked. Higher productivity demands may drive peak charging rates that can exacerbate energy costs. Demands for high efficiency may drive deep cycling of batteries and fast charge cycles. The drive for battery power can lead to faster battery degradation, an increase battery replacement costs, and may also impact energy costs. The tradeoffs in activating different energy assets and utilization of the work machine fleet are not obvious to daily operating schedules. A holistic approach to optimization of the microgrid system and work machines improves operation of the job site and microgrid system to optimize revenue from the job site.

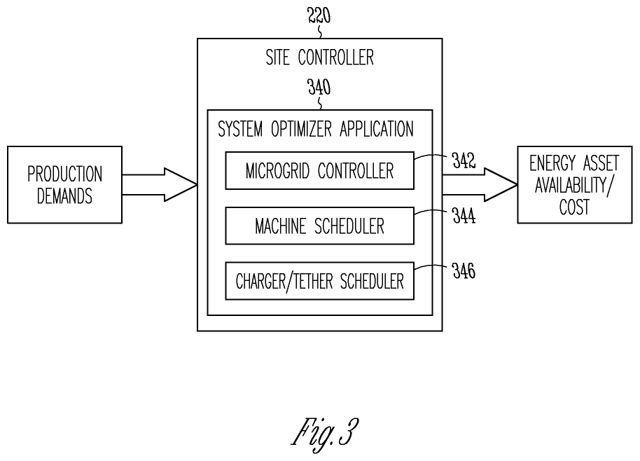

FIG. 3 is a block diagram of a site controller 220 of the microgrid system 200. The site controller 220 includes a microgrid controller 342, a machine scheduler 344, and a charger/tether scheduler 346. The site controller 220 may perform instructions included in a system optimizer application 340. The microgrid controller 342, machine scheduler 344, and charger/tether scheduler 346 may be included in the system optimizer application 340, they may be separate applications executing on the same processing circuitry of the site controller 220, or they may be separate devices. The machine scheduler 344 produces a schedule of machines for the work site according to production demands, and the charger/tether scheduler 346 produces a charging (and tethering) schedule according to the energy demands of the work machines. The site controller 220 uses the production demands and the availability and cost of energy assets of the microgrid system to determine a power dispatch schedule. The site controller 220 interacts with the microgrid controller 342 and the microgrid controller 342 delivers electric power according to the power dispatch schedule. For instance, the site controller 220 may forecast energy demand on the microgrid system 200 in real time to produce the power dispatch schedule and the microgrid controller 342 dispatches the energy assets according to the power dispatch schedule in real time to adjust the energy supplied by the microgrid system 200 based on the predicted energy demand. The microgrid controller 342 can dispatch an energy asset by sending an activation command that activates the energy asset and a command that directs the energy from the energy asset to a load or an ESS. The microgrid controller 342 may dispatch energy assets of the same type as a group of assets, or the microgrid controller 342 may dispatch energy assets individually within a group at a subgroup level. The site controller 220 may adjust the power dispatch schedule in response to changes in energy supply or cost of energy supplied forecasted by the site controller 220 to adjust the demand on the microgrid system 200.

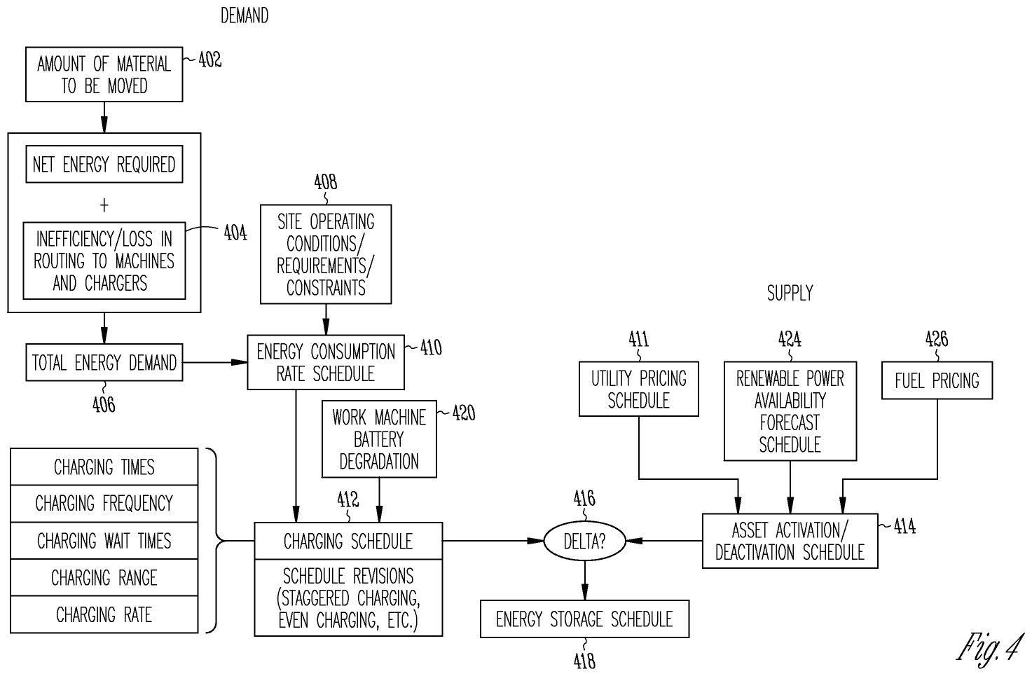

FIG. 4 is a block diagram of an example of supervision of a microgrid system performed by the site controller 220. The site controller 220 calculates the energy demand on the microgrid system over a predetermined time window (e.g., the current day, the next day, or a week). The energy demand may be the energy needed to power the electric work machines and other equipment of a job site. The site controller 220 with the microgrid controller 342 also manages the energy assets of the microgrid system 200 to supply the energy.

At block 402, the site controller 220 may receive material movement information related to the amount of material to be moved using the work machines. The site controller 220 may determine the number of work machines needed to move the material and calculate the energy demand based on the number of work machines. In some examples, at block 404, the site controller 220 calculates the energy loss involved in routing energy to the work machines and energy loss due to inefficiencies in operating the machinery. The site controller 220 may use machine performance models previously input to the site controller 220. The energy loss is added to the net energy required to move the material to calculate a total energy demand for the job site at block 406.

At block 408, the site controller 220 may receive information related to the operating conditions at the job site and any requirements or constraints that may impact energy demand at the job site, such as a schedule of when the job site is operational, availability of equipment operators, weather affecting operation of the job site, etc.

At block 410, the site controller 220 may calculate an energy consumption rate schedule for the job site over the predetermined time window using the calculated total energy demand for the job site and the operating conditions information.

At block 412, the site controller 220 generates a charging schedule for the job site. There may be a different number of chargers and work machines. The charging schedule pairs chargers 222 (and possible tether stations) of the site system 200 to work machines during the predetermined time window. The site controller 220 may take into account one or more of the charging time needed for the work machines to become charged as desired, the charging wait time for the machines, the charging frequency of the machines, the charging rate of the batteries of the machines, the charging range of the level charge on the batteries of the machines (e.g., state of charge or SOC), and the relative position of a work machine to a charging station when pairing the chargers and work machines. The charging schedule may also pair tethering substations of the microgrid system with tethered work machines.

To provide the calculated energy demand for the job site, the site controller 220 generates a power dispatch schedule at block 414. The power dispatch schedule is a schedule of activating and deactivating the energy assets of the site system 200. The power dispatch schedule also apportions the power levels of the energy assets to supply the calculated energy demand and includes power requests for the energy assets. The site controller 220 selectively activates, deactivates, and adjusts power levels of the energy assets according to the schedule when supplying the energy to the microgrid system 200.

There may be a difference or delta during the predetermined window between the energy that the microgrid controller 342 dispatches according to the power dispatch schedule and energy demand to follow the charging schedule and other work site electrical loads including the direct electrical draw of tethered machines through the tethered trolleyed arrangements. If there is a difference, it is detected at block 416. The site controller 220 may assess whether there is a difference between supply and demand during the predetermined time window or constantly in real time. At block 418, the site controller 220 generates an electric energy storage schedule that schedules charging and discharging times of the ESSs of the microgrid system. If the difference is a shortfall in energy, the energy storage schedule activates one or more ESSs to supply the shortfall in energy. If the difference in energy is a surplus, the energy storage schedule activates one or more ESSs to store the surplus of energy.

When the site controller 220 determines the energy demand from the work machines and other loads, the machine scheduler 344 may perform system optimization in real time to meet objectives for operating the job site such as reducing cost of operating the job site and increasing productivity from operating the job site. As explained previously herein, the site controller 220 and machine scheduler 344 may receive material movement information related to the amount of material to be moved using the work machines. In some examples, the site controller 220 and machine scheduler 344 determine productivity from moving the material using the electric work machines. The site controller 220 may also calculate the cost of operating and maintaining the electric work machines and the cost of operating and maintaining the microgrid system during the predetermined time window. The machine scheduler 344 can update of the machine schedules, the charger/tether scheduler 346 can update the charging schedule, and the site controller 220 can update the power dispatch schedule to optimize the productivity and operating cost from operating the electric work machines to move the amount of material.

As shown in FIG. 2, the microgrid system 200 may have a connection to the utility grid 108. At block 222 in FIG. 2, the microgrid controller 220 receives utility price information, such as price charged by the utility company per unit of energy. The microgrid controller 220 may adjust the activation/deactivation schedule in view of the utility price information by changing the activation and deactivation of energy assets in the schedule. For example, the microgrid controller 220 may charge the ESSs 210 of the microgrid system when utility prices are low and use the stored ESS energy when the utility prices are high. Similarly, the microgrid system 200 may have gensets 102 that use fuel (e.g., diesel). At block 426, the microgrid controller 220 receives fuel price information. The microgrid controller 220 adjusts the activation/deactivation schedule in view of fuel prices by changing the activation and deactivation of gensets 202 in the schedule according to the fuel price information, or using other energy assets depending on the fuel prices.

The microgrid system 200 may have renewable energy assets such as photovoltaics 204 and wind turbines 206. At block 224, the site controller 220 may forecast or predict availability of energy from renewable energy assets of the microgrid system 200. For instance, the amount of renewable energy or the availability of renewable energy from the renewable energy assets may change with weather or cloud cover. The microgrid controller 120 changes one or more of the activation, deactivation, and power levels of the renewable energy assets in the power dispatch schedule according to predicted availability and amount of renewable energy. The changes can include charging the ESSs 210 of the microgrid system 200 when the renewable energy is available in surplus or switching to alternative energy assets when the renewable energy is low or unavailable.

The ESSs 210 of the microgrid system can include batteries to store surplus energy and provide stored energy to the job site. There can be a battery degradation cost in cycling the batteries of the ESSs. The microgrid controller 120 can adjust one or both of the power dispatch schedule and the charging schedule to account for the battery degradation cost of the ESSs 210. For example, the site controller 220 can adjust the power dispatch schedule of one or more of the ESSs by changing one or more of the charging frequency of the batteries, the charging rate of the batteries, the level of charge after charging the batteries, and the level of charge after discharging the batteries. The site controller 220 can work out an optimal power dispatch schedule for the energy assets based on utility pricing schedule, forecast of availability of renewables, and availability and pricing of fuel (e.g., diesel, gas, hydrogen, etc.) used by energy assets of the microgrid system 200. The optimization may optimize productivity, or involve tradeoffs between productivity and operating costs, including future maintenance costs of equipment and energy assets.

Cycling the batteries of the power source of an electric work machine can eventually degrade the batteries of the work machine leading to a battery degradation cost related to operating the work machines. As shown in block 420 of FIG. 4, the site controller 220 can account for battery degradation of the work machines when generating the charging schedule at block 412. For example, the site controller 220 can adjust the charging schedule by changing one or more of the charging frequency of the batteries of one or more of the work machines, the charging rate of the batteries, the beginning state of charge when charging the batteries, and the ending state of charge when operating the one or more work machines. Other changes to the charging schedule can include staggering the charging of the work machines to different overlapping or non-overlapping charge windows to minimize impact of the charging on productivity, even charging of the work machines (e.g., to the same SOC), or uneven charging of the machines (e.g., to different SOC). The site controller 220 may weigh the battery degradation cost against the revenue of cycling the batteries with the objective of increasing revenue and reducing cost of operating the electric work machines during the predetermined time window.

The system optimization by the site controller 220 can fine tune the operation of the energy assets of the microgrid system 200 and the load or loads on the microgrid system 200 in a holistic manner to maximize net revenue from a job site by optimizing productivity and minimizing operating costs and energy costs.

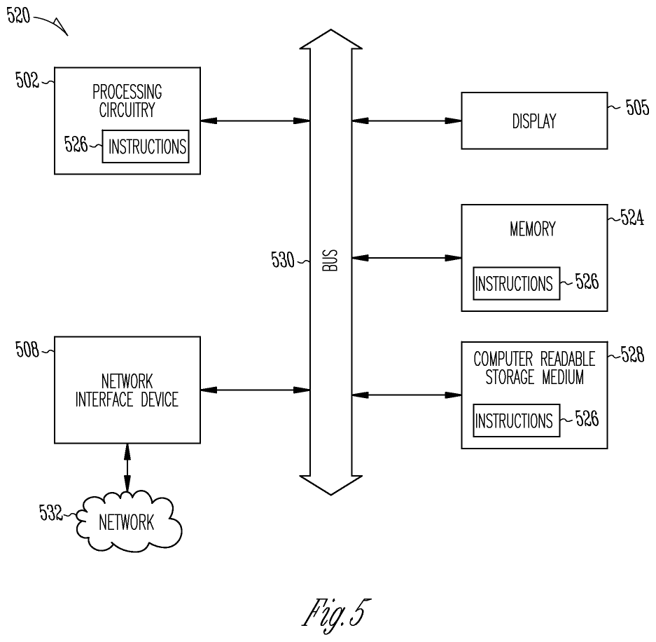

FIG. 5 is a block diagram of an example computing device 520 that can perform the functions of the site controller 120 as described herein. The computing device 520 may operate as a standalone device or may be connected (e.g., networked) to other machines. In a networked deployment, the computing device 520 may operate in the capacity of a server machine, a client machine, or both in server-client network environments. The computing device 520 may be a personal computer (PC), a tablet PC, a smartphone, an IoT device, or any machine capable of executing instructions (sequential or otherwise) that specify actions to be taken by that machine. Further, while only a single computing device 520 is illustrated, the computing device 520 may be multiple devices that individually or jointly execute a set (or multiple sets) of instructions to perform any one or more of the methodologies discussed herein, such as cloud computing, software as a service (SaaS), other computer cluster configurations.

The computing device 520 may include processing circuitry 502 (e.g., a hardware processor, a central processing unit (CPU), a hardware processor core, application specific integrated circuit (ASIC), a programmable gate array (PGA), or any combination thereof, etc.) and a memory 504 (e.g., read-only memory (ROM), dynamic random-access memory (DRAM), static memory, etc.) that may communicate via a communication interface (e.g., a bus) 530. The processing circuitry 502 can be configured to execute instructions 526 for performing the operations and steps discussed herein. For example, the instructions 526 can be included in a system optimizer application that optimizes performance of a microgrid system. The computer device 520 can further include a network interface device 508 to communicate over a network 532.

The computing device 520 can include or have access to a computer-readable storage medium 518 on which is stored one or more sets of instructions 526 or software embodying any one or more of the methodologies or functions described herein. The instructions 526 can also reside, completely or at least partially, within the memory 504 or within the processing circuitry 502 during execution thereof by the computing device 530, the main memory 504 and the processing circuitry 502 also constituting computer-readable storage media.

The term “computer-readable storage medium” should be taken to include a single medium or multiple media that store the one or more sets of instructions (or any medium that can store or encode a set of instructions for execution by the computing device 520) that cause the computing device 520 to perform any one or more of the functions of the microgrid controller described herein. These media can include, among other things, solid-state memories, optical media, and magnetic media.

The computing device 520 may further include a display unit 506, an alphanumeric input device (e.g., a keyboard), and a user interface (UI) navigation device (e.g., a mouse). In an example, one or more of the display unit, the input device, or the UI navigation device may be a touch screen display.

The instructions 526 may further be transmitted or received over the network 532 using a transmission medium via the network interface device 508 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 508 may include one or more physical jacks (e.g., Ethernet, coaxial, or phone jacks) or one or more antennas to connect to the network 532. In an example, the network interface device 508 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium capable of storing, encoding, or carrying instructions for execution by the computing device 520, and includes digital or analog communications signals or other intangible medium to facilitate communication of software or firmware.

### INDUSTRIAL APPLICABILITY

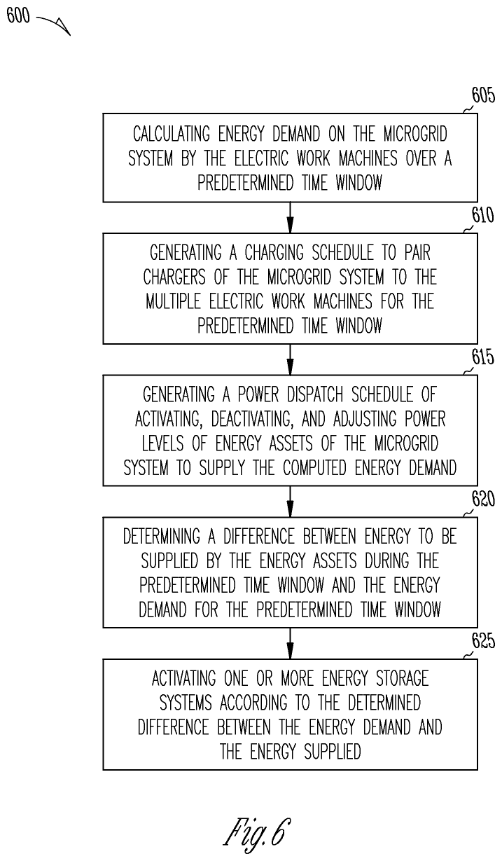

FIG. 6 is a flow diagram of an example of a method 600 of operating a microgrid system 200 for a remote work site (e.g., a mining site), such as the microgrid system 200 of FIG. 2. The method 600 may be performed by a computing resource of the microgrid system, such as a microgrid controller 220 for example or the computing device 520 of FIG. 5.

At block 605, energy demand on the microgrid system from the electric work machines to perform work at the work site during a predetermined time window is calculated. The energy demand is calculated by the computing resource of the microgrid system. The energy demand may be calculated using material movement information related to an amount of material to be moved during the predetermined time window (e.g., the amount of ore removed from a mining site during the time window). The energy demand may be calculated using the number of movable electric work machines at the job site and other equipment of the job site (e.g., non-movable work machines). In some examples, the computing resource calculates the number of work machines for the work site based on the amount of material to be moved.

At block 610, the computing resource generates a charging schedule for the work site based on the calculated energy demand. The charging schedule can pair chargers and tether stations of the microgrid system to the electric work machines of the work site. To generate the charging schedule, the computing resource may take into account the number of electric work machines, the position of the electric work machines relative to the chargers, the operating schedule of the job site, schedule of machine operators, and conditions of the job site (e.g., weather, etc.). The computing resource may also take into account a desired charge rate for the batteries of the work machines, and the desired level of battery charge after the charging, and the desired level of the battery charge before the next charging. The battery charge rate of the chargers themselves may also be included in the calculations to generate the charging schedule.

At block 615, the computing resource generates an power dispatch schedule for the energy assets of the microgrid system. The power dispatch schedule is a schedule of activating, deactivating, and adjusting power levels of energy assets of the microgrid system to supply the computed energy demand. The computing resource selectively activates, deactivates, and adjusts the energy assets during the predetermined time window according to the power dispatch schedule.

The computing resource of the microgrid system may change one or both of the charging schedule and the activation/deactivation schedule to optimize performance of the work site during the predetermined time window. The performance may be optimized by optimizing the tradeoff between productivity of the work site and cost of operating the work site. The productivity may include the amount of the material moved using the electric work machines, and the cost of operating the work site may be the cost of operating the electric work machines and the cost of operating the microgrid system.

The cost of operating the electric work machines can include maintenance costs of operating the work machines and degradation costs of the work machines such as battery degradation cost for example. The computing resource can adjust the charging schedule to reduce the cost of operating the work machines such as by changing the charging schedule to reduce the battery degradation cost.

The cost of operating the microgrid system can include the maintenance costs and the degradation costs associated with operating the energy assets. The cost of operating the microgrid system can also include utility pricing schedule during the predetermined time window, a prediction of availability of renewable energy assets during the predetermined time window, and a cost of operating nonrenewable energy assets during the predetermined time window (e.g., fuel costs). The computing resource can adjust the activation/deactivation schedule to change the allocation of the utility, non-renewable energy assets, and the renewable energy assets in the activation/deactivation schedule to reduce cost of operating the energy assets and optimize the revenue from operating the electric work machines during the predetermined time window.

When the computing resource arrives at a solution to the optimization of the microgrid system and work site, at block 620, the solution may involve a gap or mismatch between the energy demanded by the work machines and the energy supplied by the energy assets during the predetermined time window. This may be especially true for initial solutions determined by the computing device. The mismatch may involve a shortfall in energy or may involve a surplus in energy.

At block 625, the computing resource activates one or more ESSs according to the determined difference between the energy demand and the energy supplied. The computing resource may also modify the charging schedule to the extent that is does not impact productivity at the work site. The activation and deactivation of the ESSs and the adjusting of the charging schedule is included in the optimization, and battery degradation costs of the ESSs and the effect of productivity on changing the charging schedules are considered and optimized by the computing resource.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A method of controlling a work site with multiple work machines to schedule the work machines to perform work and to provide energy to the work site, the method comprising:
calculating, by a site controller of the work site, energy demand by the work machines to perform the work over a predetermined time window;
generating a charging schedule for the predetermined time window, wherein the charging schedule pairs chargers of the work site to the work machines and includes charging wait times for charging the multiple work machines;
generating a power dispatch schedule of activating and deactivating energy assets of a microgrid system of the work site and apportioning power levels of the energy assets to supply the calculated energy demand during the predetermined time window;
determining a difference between energy to be supplied by the energy assets during the predetermined time window and the energy demand for the predetermined time window; and
operating the energy assets according to the power dispatch schedule and the chargers according to the charging schedule, and activating one or more energy storage systems of the microgrid system according to the determined difference between the energy demand and the energy supplied.

2. The method of claim 1, including:
receiving material movement information related to an amount of material to be moved during the predetermined time window;
calculating, by the site controller, revenue from moving the material using the work machines, a cost of operating the work machines, and a cost of operating the microgrid system during the predetermined time window; and
wherein the generating the charging schedule includes the microgrid controller optimizing productivity from operating the work machines using the charging schedule for the work machines and the activation/deactivation schedule for the energy assets.

3. The method of claim 2, wherein the generating the charging schedule includes:
calculating a number of the work machines to charge using the microgrid system according to the received material movement information;
determining travel time of the work machines to the chargers; and
determining charging times and charging wait times of the work machines with the chargers.

4. The method of claim 3, wherein the generating the charging schedule includes:
determining a charge range and a charge rate of batteries of the work machines;
determining a charge rate of the chargers of the work site; and
pairing the work machines to the chargers using the determined charge range and charge rates.

5. The method of claim 2, wherein the calculating the cost of operating the work machines includes:
calculating, by the microgrid controller, a battery degradation cost of cycling batteries of the work machines; and
generating the charging schedule to reduce the battery degradation cost to optimize the revenue from operating the work machines during the predetermined time window.

6. The method of claim 2, wherein the calculating the cost of operating the energy assets includes:
determining, by the site controller, a utility pricing schedule during the predetermined time window, a prediction of availability of renewable energy assets during the predetermined time window, and a cost of operating nonrenewable energy assets during the predetermined time window; and
adjusting use of the utility, non-renewable energy assets, and the renewable energy assets in the power dispatch schedule to optimize the revenue from operating the work machines during the predetermined time window.

7. The method of claim 2, wherein activating the one or more energy storage systems includes:
calculating, by the site controller, a degradation cost of using the one or more energy storage systems; and
activating the one or more energy storage systems according to the determined difference between the energy demand and the degradation cost of using the one or more energy storage systems.

8. The method of claim 1, wherein the calculating the energy demand on the microgrid system includes:
receiving, by the site controller in real time, material movement information related to an amount of material to be moved using the electric work machines; and
computing the energy demand in real time using the received material movement information; and
wherein the generating the charging schedule includes the site controller updating the charging schedule in real time.

9. The method of claim 1, wherein the generating the power dispatch schedule includes:
receiving, by the site controller in real time, one or more of a utility price for energy from a utility grid input to the microgrid system, a prediction of availability of energy from renewable energy assets of the microgrid system, and price of fuel for non-renewable energy assets of the microgrid system; and
scheduling activation, deactivation, and power level apportioning of the renewable and non-renewable energy assets in real time to meet the calculated energy demand and minimize cost of operating the microgrid system.

10. A microgrid system for a work site to provide energy to multiple work machines, the system comprising:
multiple energy assets including renewable and non-renewable energy assets;
a computing resource; and
a system optimizer application to execute on the computing resource and configured to:
calculate energy demand on the microgrid system by the work machines over a predetermined time window;
calculate a cost of operating the microgrid system and the work machines during the predetermined time window;
determine a schedule to optimize productivity of operating the work machines during the predetermined time window, wherein the schedule includes a charging schedule for the work machines and a power dispatch schedule for energy assets of the microgrid system; and
activate and deactivate the energy assets of the microgrid system, and apportion power levels of the energy assets during the predetermined time window according to the activation/deactivation schedule.

11. The system of claim 10, wherein the system optimizer application is configured to:
receive material movement information related to an amount of material to be moved during the predetermined time window;
determine revenue information using the material movement information; and
generating the charging schedule and the power dispatch schedule to optimize the revenue of operating the electric work machines to move the amount of material.

12. The system of claim 11, wherein the system optimizer application is configured to:
determine a number of the work machines to be powered by the microgrid system according to the material movement information; and
calculate the energy demand using the determined number of the work machines.

13. The system of claim 10, wherein the system optimizer application is configured to:
determine a charge range and a charge rate of batteries of the work machines;
determine a charge rate of chargers of the work site; and
pair the work machines to the chargers in the charging schedule using the determined charge range and charge rates.

14. The system of claim of claim 10, wherein the system optimizer application is configured to:
calculate a battery degradation cost of cycling batteries of the work machines; and
generate the charging schedule to reduce the battery degradation cost to optimize the revenue from operating the work machines during the predetermined time window.

15. The system of claim 10, wherein the system optimizer application is configured to:
receive information of utility pricing from a utility grid input to the microgrid system during the predetermined time window;
predict availability of the renewable energy assets of the during the predetermined time window;
determine a cost of operating the non-renewable energy assets during the predetermined time window; and
schedule use of the utility, non-renewable energy assets, and renewable energy assets in the power dispatch schedule according to the utility pricing information, the availability of the renewable energy assets, and the cost of operating the non-renewable energy assets.

16. The system of claim of claim 10, including:
one or more energy storage systems; and
wherein the system optimizer application is configured to:
calculate a difference between the calculated energy demand and an amount of energy supplied according to the power dispatch schedule;
calculate a degradation cost of using the one or more energy storage systems; and
activate the one or more energy storage systems according to the calculated difference between the energy demand and the degradation cost of using the one or more energy storage systems.

17. A site controller of a work site that includes microgrid system having multiple types of energy assets, the site controller comprising:
processing circuitry configured to:
calculate energy demand on the microgrid system by multiple work machines over a predetermined time window;
generate a charging schedule to pair chargers of the work site to the work machines for the predetermined time window;
generate a power dispatch schedule of activating and deactivating energy assets of the microgrid system and apportioning power levels of the energy assets to supply the calculated energy demand;
determine a difference between energy to be supplied by the energy assets during the predetermined time window and the energy demand for the predetermined time window; and
operate the energy assets according to the power dispatch schedule and activate one or more energy storage systems according to the determined difference between the energy demand and the energy supplied.

18. The site controller of claim 17, wherein the processing circuitry is configured to:
receive material movement information related to an amount of material to be moved during the predetermined time window;
calculate revenue from moving the material using the work machines, a cost of operating the work machines, and a cost of operating the microgrid system during the predetermined time window; and
optimize productivity from operating the electric work machines using the charging schedule for the electric work machines and the power dispatch schedule for the energy assets.

19. The site controller of claim 18, wherein the processing circuitry is configured to:
calculate a battery degradation cost of cycling batteries of the work machines; and
generate the charging schedule to reduce the battery degradation cost to optimize the revenue from operating the work machines during the predetermined time window.

20. The site controller of claim 17, wherein the processing circuitry is configured to:
receive material movement information related to an amount of material to be moved during the predetermined time window;
calculate a number of the work machines to charge using the chargers of the work site according to the received material movement information;
determining a charge range and a charge rate of batteries of the work machines;
determine a charge rate of the chargers of the work site; and
pair the work machines to the chargers in the charging schedule using the determined charge range and charge rates.
